(19) United States
(12) Patent Application Publication
(10) Pub. No.: US 2011/0113868 A1
(43) Pub. Date: May 19, 2011

(54) PROCESS OF MONITORING THE CONTAMINATION OF BARRELS

(75) Inventors: Pascal Chatonnet, Bordeaux (FR); Stephane Boutou, Jugazan (FR)

(73) Assignee: LABORATOIRE EXCELL, Merignac (FR)

(21) Appl. No.: 12/867,611

(22) PCT Filed: Feb. 11, 2009
(86) PCT No.: PCT/EP09/51565

§ 371 Date: Jan. 21, 2011

(30) Foreign Application Priority Data
Feb. 22, 2008 (FR) 0851143

(51) Int. Cl. G01N 1/10

(52) U.S. Cl. 73/64.56

(57) ABSTRACT

This invention consists of a process for detecting contamination in a batch comprising at least one wooden container (1), intended for aging an alcoholic beverage. According to the invention, it comprises:

a phase where the sample to be assayed for contaminants is prepared, during which:
a) a sample is collected from a volume of water after having been brought into contact with stirring, with the entire inner surface of each container in the batch to be analyzed, the aforementioned volume of water only being used once for each container, having been heated to a controlled temperature;
b) said collected sample or assembly with equal proportions of the water samples collected from each container in the batch to be analyzed is transferred to a contaminant assay phase,
   during which:
c) initially, a threshold value for the contaminant concentration corresponding to a risk of contamination of the container is determined;
d) then the mixture or the sample is assayed for contaminants;
e) the contaminant concentration measured is compared with the threshold value to determine whether the batch is contaminated;
f) when the concentration is over the threshold value, indicating that the batch is contaminated and when the batch comprises at least two containers, the operations in stages a), and e) are repeated for each container in the batch to locate the contaminated container(s) within that batch.

This invention concerns a process of monitoring the contamination of barrels, which are intended, in general, for aging alcoholic beverages, such as wine or brandy, particularly to detect certain contaminants present in the pieces of wood in the barrels, which would make them unfit for use.

Moreover, quite clearly, the process described in this invention is more generally applicable to detecting contamination in all types of wooden containers intended for aging alcoholic beverages.

It is known that when a wine or must, or other alcoholic beverage, is stored in a wooden container, particularly a barrel, it gradually absorbs a certain number of constituents from the wood via diffusion phenomena. The constituents released vary according to the origin of the wood and the toasting of the staves.

The quality of the wine is thus closely dependent on the quality of the wood used to make the new barrel. Consequently, contaminated wood may release trace contaminants into the beverage during aging, for example, compounds in the phenol or chloroanisole families, thus causing organoleptic spoilage and/or even a human health risk.

In the case of new barrels, contamination may occur while the stavewood is being seasoned in the open air in a wood lot, over a period of 1 to 3 years. It may be also be due to compounds used to treat the wood.

To remedy these contamination problems before assembling the barrels, the coopers check for contamination by taking random, localized wood samples from stavewood in storage or staves to be used in a barrel, to check whether the wood is contaminated before final assembly.

However, it is known that contamination does not affect the pieces of wood uniformly and, sometimes, a small area of wood may be affected by highly-localized contamination, which penetrates to varying depths.

Furthermore, only a fraction of the contaminants present in the wood is likely to migrate into the wine. Furthermore, taking samples from a finished barrel is likely to affect its integrity.

This type of contamination detection process, using current techniques, is not capable of detecting and quantifying the level of contamination with any degree of accuracy. Furthermore, the measurement obtained indicates contamination in a localized area and is not representative of the entire wood surface that will be in contact with the wine.

Winemakers change their barrels every two or three years, or even every year, depending on their needs and tastes. Used barrels are generally re-used by other winemakers for certain types of wine with lower organoleptic quality requirements. When a clean barrel has been used to age a contaminated wine, the contaminant compounds in the wine may contaminate it by being absorbed into the wood pores. The barrel can then contaminate another wine put into it for aging.

The process for detecting contamination described above is not capable of determining the level of contamination in used barrels. it requires wood samples from the used barrels, which necessitates dismantling the barrel, or even destroying it.

This invention provides a process capable of determining the contamination affecting all, or almost all, the surface of a barrel that will be in direct contact with the aging wine, unlike the existing process, which consists of random measurements that are not representative of the surface actually in contact with the product. The proposed process is quick and simple to use and does not necessitate dismantling the barrels.

The key concept of this invention is to detect contamination directly in finished new barrels ready for aging or used barrels, on the principle that certain contaminants, such as chloroanisoles and chlorophenols, are easily extractable, i.e. likely to migrate easily and rapidly into wine stored in the barrels.

Rather than analyzing random samples of wood, this invention proposes a solution for analyzing the scalding water used by coopers to check the watertightness of the barrels or by end-users to prepare them prior to filling them with wine. The advantage of this solution is that it covers the entire inner surface involved in wood-beverage exchanges and is fast, as it does not require any additional operations on the part of the cooper. Furthermore, the use of scalding water provides an easy, non-destructive method for high-temperature extraction of any contaminants.

Consequently, the objective of this invention is a process for detecting contamination in a batch, comprising at least one wooden container, intended for aging an alcoholic beverage, said process consisting of the following:

a phase where the sample to be assayed for contaminants is prepared, during which:
a) a sample is collected from a volume of water after having been brought into contact with stirring, with the entire inner surface of each container in the batch to be analyzed, with stirring, under specified conditions, the aforementioned volume of water only being used once for each container,
b) said sample collected if the batch has a single container or assembly in the equal proportions of all water samples collected from each container in the batch to be analyzed is then sent to a contaminant assay phase;
   during which:
c) initially, a threshold value for the contaminants, known as the “rejection threshold”, is determined experimentally, corresponding to a risk of contamination of the container, i.e. a contaminant content likely to have a negative impact on the organoleptic quality of the product to be housed in the container, which varies according to the product to be stored in the container;
   d) the sample or the mixture in the recipient is then analyzed for contaminants;
e) the contaminant concentrations measured are compared with the threshold value to determine whether the batch is contaminated;
f) if the contaminant concentration measured in step e) is over the threshold value, indicating that the batch is contaminated and when the batch comprises at least two containers, consisting of repeating the operations in steps a) and e) for each container in the batch to locate the contaminated container(s) within that batch.

Thus, as explained above, the basic concept of this invention is to determine the risk of contamination during use by assaying the contaminants present in a sample of water that has been in contact with the entire inner surface of each container in a batch.

The contaminant concentration in the water indicates the degree of contamination of the containers.

The solution proposed in this invention may be used to test a batch of containers or to test each individual container.

In order to reduce the cost, this process may be applied to an entire batch of containers, rather than testing each container individually.

The water is collected from all the containers in the batch and mixed prior to the assay, to detect contaminants in the entire batch.

The number of containers per batch depends on the degree of risk of contamination to be determined by the assay. The larger the number of containers in the batch, the more dilute the solution to be analyzed. The maximum number of containers per batch is between 5 and 20, due to the detection and quantification limits, which depend on the analysis technique used, as well as the type of contaminant.

For example, to assay the risk of contamination due to 2,4,6-trichloroanisole (TCA), which has a defect threshold around 3 ng/L, it is not advisable to assemble samples from over 20 containers. A maximum of 5 containers is recommended for greater safety.

The term “defect threshold” refers to the concentration of a contaminant in wine above which an organoleptic defect is perceptible.

This method comprises an additional step b′) after the step b) in which a recipient is filled with said sample collected of the mixture thus obtained in the step b), said recipient being sealed with an inert, watertight stopper, and transferred to the contaminant assay phase.

Another enhanced embodiment of this invention consists of adding a stabilizing agent to the recipient before it is sealed. This stabilizing agent is a mineral antiseptic, e.g. either sodium fluoride, sodium metabisulfite, sodium silicate, or sodium benzoate or any other form of antiseptic not likely to interfere in the analysis. The concentration of this stabilizing agent is preferably around 100 mg/L.

Even if the recipient is hermetically sealed and stabilized, it is advisable to send the recipient containing the mixture to be analyzed within 24 hours after taking the sample of hot water mixture, to prevent the sample from being contaminated or degraded by the environment during storage and transport, prior to analysis.

The contact time between the hot water and the inner surface of the container should, preferably, be at least 100 seconds, with constant stirring, to extract the molecules trapped in the wood pores of the container and in order to fully take into account the entire inner surface of the container.

Another enhancement is to analyze the quality of the water used during step a) on a regular basis, at least once per month, to check that any contamination actually originates from the contaminated wood and not from the water.

Preferably, the water used in step a) is water heated to a temperature between 50 and 80° C.

Preferably, ethanol is incorporated in water for the purpose of adjusting the solvation of the water.

In one particularly useful enhancement, the water collected in step a) was used to check the watertightness of the container. Thus for coopers, the solution proposed in this invention does not require an additional step, as checking watertightness is a key step in the manufacture of wooden containers, such as barrels. Furthermore, the phase of preparing the sample for the assay does not require an operator with any specific skills.

In another, particularly interesting, enhancement to this invention, the process includes an additional step where a correlation curve is plotted for each contaminant, comparing the contaminant content in beverages stored in the container for a specific time and the corresponding contaminant concentration for the container, in order to determine a contamination test rejection threshold corresponding to a contaminant concentration likely to affect the organoleptic quality of the beverage.

This rejection threshold is between 0.1 ng/L et 1.0 ng.L.

The contaminant content in the beverage corresponds to the contaminant concentration that has actually migrated into a beverage in contact with the surface of the wood within a specified time period. The timeframe considered may be from 6 months to two years.

The contaminant concentration for the container is the value determined using samples of water that have been in contact with the inner surface of the container.

In general, this process is applicable to all types of wooden container, but it is particularly suitable for new or used oak barrels intended for aging red wines.

Other advantages and characteristics of the invention will become apparent from the description of a non-restrictive set of operating methods, illustrated by figures showing:

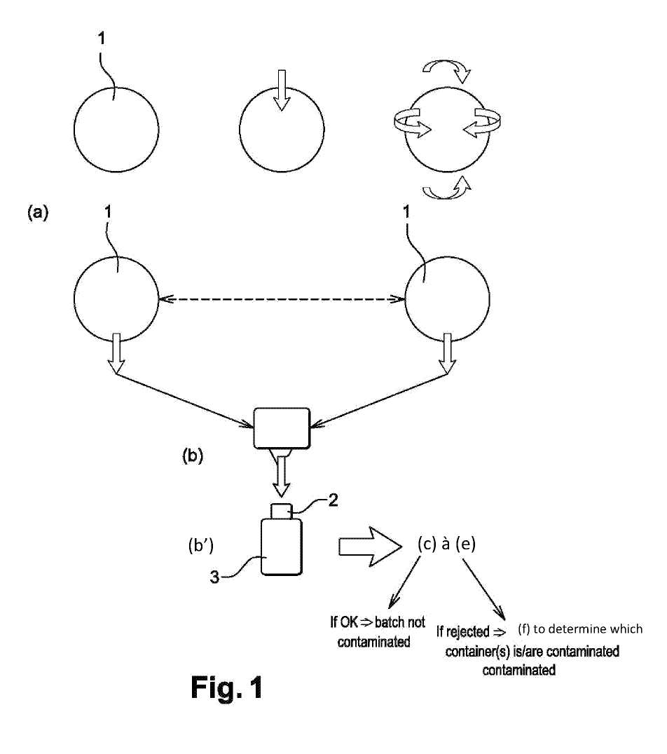

FIG. 1: a flow chart of the various steps in the contamination testing process, as described in the invention;

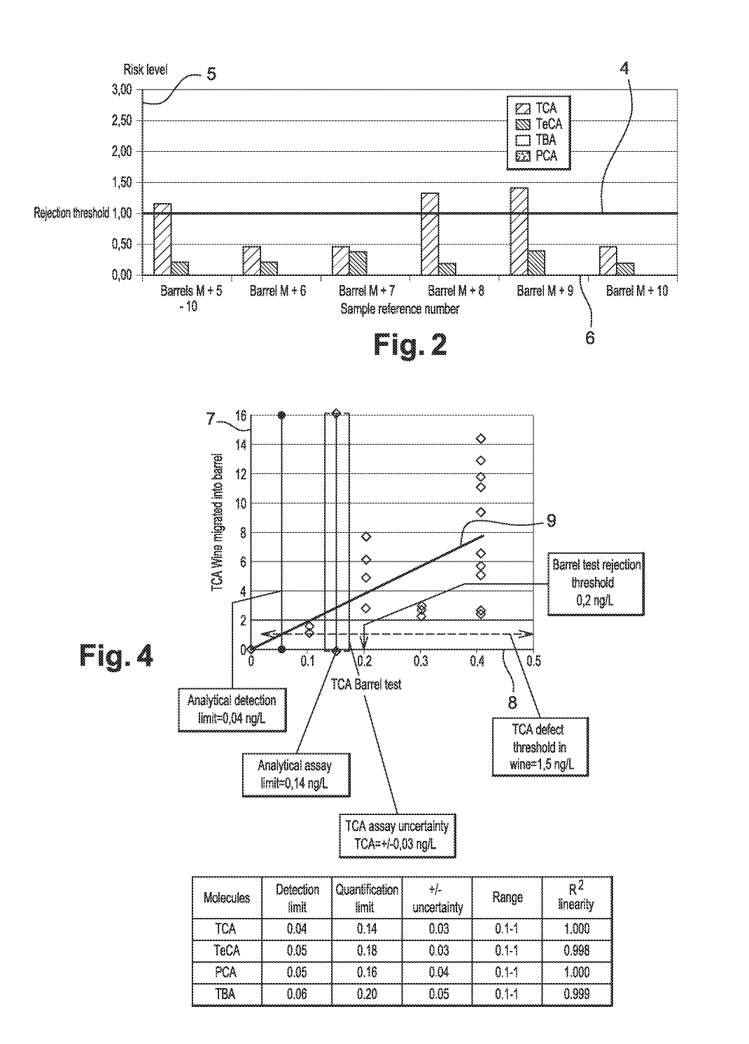

FIG. 2: contamination test results illustrating the process for 6 batches of barrels, each batch comprising 5 barrels;

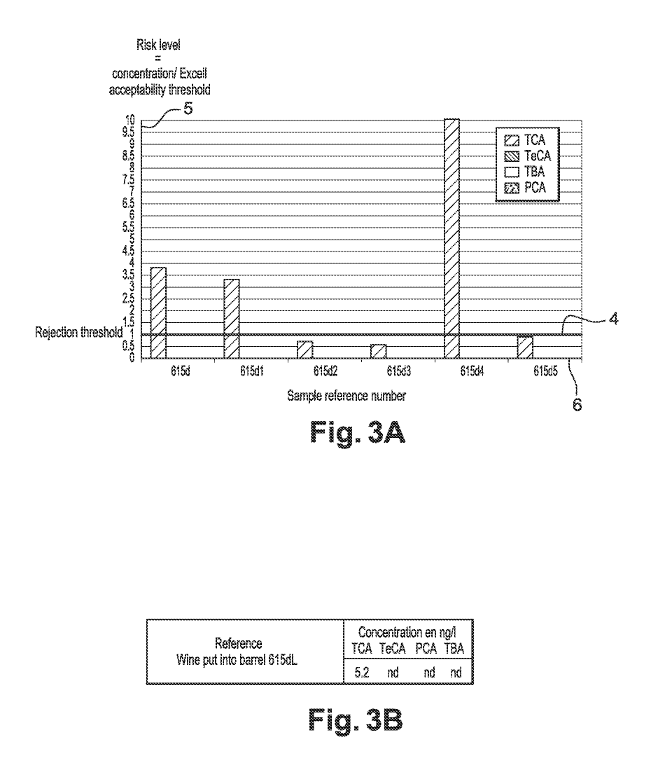

FIG. 3: contamination test results for each individual barrel in a contaminated batch,

FIG. 4: correlation curve comparing the TCA concentration that had actually migrated into the wine and the TCA content found by testing the barrel.

FIG. 1 illustrates the various steps in the process described by this invention, as presented above.

In the first step (a), a sample is collected from a volume of hot water that has been in contact with stirring with the entire inner surface of a barrel, 1, in each batch to be tested. This volume of hot water is used once for each barrel and heated to a controlled temperature. The hot water is sprayed on the inner surface of the barrel at a controlled pressure between 0.2 and 0.5 bars. The hot water used at this step is preferably pure water, heated to a temperature between 50 and 80° C.

We can also consider the use of water at room temperature. However the efficiency of extraction of contaminants is reduced. This reduction may be offset by adjusting the method parameters such as duration of contact between water and the inner surface of the container. This reduction may be offset by a change in parameter of the analytic method used to measure the contaminant concentration.

In an enhanced embodiment of the invention, around 10 to 13% ethanol may be added to the pure water to increase its solvation, thus enhancing extraction of the target contaminants and reducing the detection threshold of the analysis.

Step (a) is repeated for each container in the batch to be tested.

In the second step (b), the water samples collected from each barrel in the batch to be tested are mixed together in equal proportions in order to obtain a homogeneous mixture. When the batch includes a single container, the sample collected from the volume of water used for the container is used for the determination of contaminants phase. If desired, it was also possible to analyze not a batch, but the containers individually.

In an additional step b′), a 30 mL recipient, 3, is filled with the mixture thus obtained and the recipient is then sealed with an inert, watertight stopper, 2. This recipient is then sent to the laboratory for the contaminant assay phase. The recipient is labeled with the batch number of the barrels to facilitate rapid identification. This recipient should preferably be disposable. A stabilizing agent is added to the mixture to stabilize it prior to analysis.

This stabilizing agent may, for example, be a compound such as sodium fluoride.

Steps (a), (b), and the additional step b′) are carried out on site, i.e. directly by the barrel manufacturer or the winemaker (in the case of used barrels).

In one embodiment of the invention and when it is possible to carry out the determination of contaminants phase on site, it is not necessary to fill the sample or the mixture in a recipient.

The contaminant assay phase consists of the following steps, wherein:
in step (c), a threshold value for the contaminant concentration or a rejection threshold for the contamination test, corresponding to a risk of contamination of the container likely to affect the quality of a wine aged in that contaminated container, is determined experimentally in advance. This value is determined on the basis of a preliminary test carried out on the same type of container. Generally this threshold value is lower than the perceptible defect threshold. For example, the perceptible organoleptic defect threshold for TCA is on the order of 1.5 to 3 ng/L, corresponding to the threshold detectable by a wine taster.
in step (d), the mixture in the recipient is assayed for contaminants using various well-known analytical methods, such as gas-phase chromatography combined with mass spectrometry.
in step (e), the concentration measured in the assay is compared with the threshold value to determine whether the batch is contaminated.

When the concentration exceeds the rejection threshold, indicating that the batch is contaminated and when the batch comprises at least two containers, it is then necessary to carry out an additional step, (f), which consists of repeating the operations in steps a) and e) for each container in the contaminated batch individually, in order to identify which container(s) in the batch are contaminated. These operations may be carried out at least three times for the purpose of repeat analyses, without any risk of distorting the test results, as rinsing with hot water only extracts tiny amounts of contaminants and only partially removes them.

Thus, this step provides a very accurate, quantitative identification of containers in the same contaminated batch that are actually contaminated and unfit for use, particularly for aging wine.

It should be noted that the process described in this invention may be used to test for contamination in all types of wooden containers used for aging all types of alcoholic beverage (wine, brandy, beer, etc.) and is particularly effective for detecting contaminant that are easily extracted from the wood of the container, such as compounds in the haloanisole group, compounds in the halophenol group or any other pollutant, whose presence above a certain threshold affects the organoleptic quality of the beverage.

In general, the contaminants to be assayed may consist of one of the constituents of the haloanisole group, comprising 2,4,6-trichloroanisoles (TCA), 2,4,6-triboanisoles (TBA), 2,3,4,6-tetrachloroanisoles (TeCA), and pentachloroanisole (PCA), one of the constituents of the halophenol group, comprising 2,4,6-trichlorophenols (TCP), 2,3,4,6-tetrachlorophenols (TeCP), and pentachlororophenols (PCP), one of the constituents of the volatile phenol family, comprising 4-ethyl-4-phenol and 4-ethylguaiacol, one of the constituents of the polycyclic aromatic hydrocarbon group, as well as acetic acid or ethyl acetate.

One application of the process, as described above, to test for TCA, TeCA, TBA, and PCA contaminants belonging to the haloanisole group, will now be described with reference to FIG. 2.

FIG. 2 shows an example of the type of graph obtained at the end of the assay phase, representing the risk level (Y axis, 5) measured for each of the 6 batches of barrels (X axis, 6).

In the example of the invention process illustrated here, the rejection threshold, corresponding to the horizontal line, 4, is set in this case at 1, which corresponds to the ratio of the contaminant concentration measured to the acceptability threshold for this molecule. Above this threshold, the contaminant concentration in the container is such that there is a risk of deterioration of the organoleptic quality of the wine aged in such a contaminated barrel.

Of course, this value may vary depending on the degree of contamination risk. The results shown concern 6 batches of 5 barrels, each batch identified by a reference number: M+5, M+6, M+7, M+8, M+9, and M+10. This reference number may, for example, consist of a figure followed by the date the water sample is collected.

The hot water from all the barrels in the batch is mixed together by an operator on site. Unlike the previous technique, this sample and mixing phase does not require any special technical skills on the part of the operator.

The recipients are preferably sent off for analysis within 24 hours after sampling to avoid any later environmental contamination during storage and transport. The recipients are preferably hermetically sealed using a stopper made of inert material.

The graph shows that no TBA or PCA contaminants were detected in the 6 batches analyzed. This absence of detection does not necessarily reflect the absence of these contaminants, but may also be due to concentrations so low that they are undetectable by the analytical methods used. On the contrary, the risk level for TCA and TeCA in the batches identified as M+5, M+8, and M+9 was considerably above the rejection threshold that had been determined. In this case, it was necessary to continue with the additional step (g), repeating steps (a) and (c) to (f) to check the quality of each barrel in the batch, M+5, M+8, and M+9, to identify which individual barrel(s) were contaminated.

FIG. 3.A and FIG. 3.B illustrate an example of individual testing of each barrel in a contaminated batch, consisting of 5 barrels, identified as 615d. Steps a) and c) to f) were repeated for each of the barrels identified by a specific reference number, i.e.: 615d1, 615d2, 615d3, 615d4, and 615d5.

The graph shown in FIG. 3.A, where the Y axis represents the risk level and the X axis the sample reference number shows that the barrels identified by the reference numbers 615d1 and 615d4 did not meet the required quality criteria, i.e.: the TCA content measured was above the rejection threshold.

To demonstrate the relevance of this contamination test, a red wine (12%) was deliberately stored in the contaminated barrel identified as 615d1 for 6 months. The wine was analyzed at the end of this period, particularly the TCA, TeCA, PCA, and TBA concentrations in the wine, to determine the quantity of undesirable molecules that had actually migrated into the red wine during this period. The table in FIG. 3.B clearly shows that the wine aged in this barrel was contaminated, with a concentration of TCA detectable on tasting, 5.2 ng/L, i.e. considerably above the organoleptic perception threshold in red wine, which is generally on the order of 2 to 3 ng/L.

These tests clearly demonstrate that determining the contaminant content on the basis of samples of hot water or water at room temperature provides an effective contamination test for barrels. Thus, thanks to this quantitative test of the contamination in one or more barrels, barrel manufacturers are able to give these barrels an appropriate treatment before they are shipped to winemakers or excluding them finally.

FIG. 4 shows results matching the concentration of contaminants in a barrel determined using the process described in the invention compared to the concentration of contaminants that actually migrated into wine aged in the same type of barrel.

The graph shown in FIG. 4 is a correlation curve, 9, plotting the TCA concentration in a barrel (X axis, 8) against the concentration of TCA that migrated into wine aged in the barrel (Y axis, 7). The curve obtained is a straight line with a linearity coefficient of around 1.

The table in FIG. 4 summarizes the data for other compounds in the same family as TCA.

Thus, on the basis of these results, it is possible to obtain the rejection threshold for the barrel test, at the intersection of the correlation curve and the perceptible organoleptic defect threshold, represented by a dotted horizontal line, 10, taking into account the uncertainty of the assay, the analytical detection threshold, and the analytical assay limit.

In the example illustrated in FIG. 4, the defect threshold for TCA in a finished product, such as wine, is 1.5 ng/L, the detection threshold is 0.04 ng/L, the assay limit is 0.14 ng/L, and the uncertainty of the assay is +/−0.03 ng/L, consequently the rejection threshold of the barrel test according to the process described in this invention is 0.2 ng/L, considerably below the defect threshold.

1-15. (canceled)

16. A process for detecting contamination in a batch, comprising at least one wooden container (1), intended for aging an alcoholic beverage, said process consisting of the following:
a phase where the sample to be assayed for contaminants is prepared, during which:
a) a sample is collected from a volume of water after having been brought into contact with stirring, with the entire inner surface of each container in the batch to be analyzed, said volume of water only being used once for each container,
b) said collected sample if the batch has a single container or assembly in the equal proportions of the water collected from each container in the batch to be analyzed is then sent to a determination of contaminants phase;
during which:
c) initially, a threshold value for the contaminant concentration corresponding to a risk of contamination of the container is determined;
d) then the mixture or the sample is assayed for contaminants;
e) the contaminant concentrations measured are compared with the threshold value to determine whether the batch is contaminated;
f) when the concentration is over the threshold value, indicating that the batch is contaminated and when the batch comprises at least two containers, the operations in stages a), and e) are repeated for each container in the batch to locate the contaminated container(s) within that batch.

17. The process according to claim 16, characterized by an additional step b′) after said step b) in which, a recipient (3) is filled with the mixture or the sample; said recipient being sealed with an inert, watertight stopper (2), and sent for the contaminant assay phase.

18. The process according to claim 17, characterized by the addition of a stabilizing agent to the recipient (3) before it is sealed.

19. The process according to claim 18, characterized by the use of a stabilizing agent consisting of a compound such as: sodium fluoride, sodium metabisulfite, sodium silicate, or sodium benzoate, at a concentration no higher than 100 mg/L.

20. The process according to claim 16, characterized by the fact that the batch comprises at least five wooden containers.

21. The process according to claim 17, characterized by fact that the contaminant assay is carried out within 24 hours after the sample or the mixture is prepared in step (c).

22. The process according to claim 16, characterized by the fact that the contact time of the hot water with the inner surface of the container is at least 100 seconds.

23. The process according to claim 16, characterized by the fact that the water used in step a) is heated to a temperature between 50 and 80° C. or water at room temperature.

24. The process according to claim 23, characterized by the addition of ethanol to the pure water, the maximum percentage of ethanol added to the water being 13%, for the purpose of adjusting the solvation of the water.

25. The process according to claim 23, characterized by the fact that the quality of the water used during step a) is tested regularly, at least once per month.

26. The process according to claim 23, characterized by the fact that the water used during step a) is the water used to test the watertightness of the container.

27. The process according to claim 16, characterized by the fact that the contaminants to be assayed consist of constituents of the chloroanisole group, comprising 2,4,6-trichloroanisole (TCA), 2,4,6-triboanisole (TBA), 2,3,4,6-tetrachloroanisole (TeCA), and pentachloroanisole (PCA), one of the constituents of the chlorophenol group, comprising 4,6,5-trichlorophenol (TCP), 2,4,6,2-tetrachlorophenol (TeCP), and pentachlororophenol (PCP), in the volatile phenol family, comprising 3-ethyl-4-phenol and 4-ethylguaiacol, one of the constituents of the polycyclic aromatic hydrocarbon group, acetic acid, or ethyl acetate or other contaminants may affect the taste and smell of the contents in the container.

28. The process according to claim 16, characterized by the fact that it includes an additional step in which a correlation curve is plotted for each contaminant, comparing the contaminant concentration in the beverage after a specified time in the container and the corresponding contaminant concentration of the container, in order to determine the threshold value for contaminant concentrations.

29. The process according to claim 28, characterized by the fact that the rejection threshold value in the contamination test for TCA contamination is between 0.1 ng/L and 1.0 ng/L.

30. The process according to claim 16, characterized by the fact that the containers are wooden barrels, in particular new or used Oak barrels, for aging all types of alcoholic beverages.

31. The process according to claim 24, characterized by the fact that the quality of the water used during step a) is tested regularly, at least once per month.
